(19) United States
(12) Patent Application Publication
(10) Pub. No.: US 2020/0347816 A1
(43) Pub. Date: Nov. 5, 2020

(54) Generating Electricity Using the Outfall of a Waste Water Treatment Plant

(71) Applicant: John B. Mcclurkin, JR., Frederick, MD (US)

(72) Inventor: John B. Mcclurkin, JR., Frederick, MD (US)

(21) Appl. No.: 16/865,337

(22) Filed: May 2, 2020

Related U.S. Application Data
(60) Provisional application No. 62/920,471, filed on May 2, 2019.

(51) Int. Cl. F03B 13/08; H02K 7/116; H02K 7/18

(52) U.S. Cl. CPC F03B 13/08; H02K 7/1823; H02K 7/116

(57) ABSTRACT

Described is a process whereby the water discharged from a Waste Water Treatment Plant (WWTP) can be used to generate electricity.

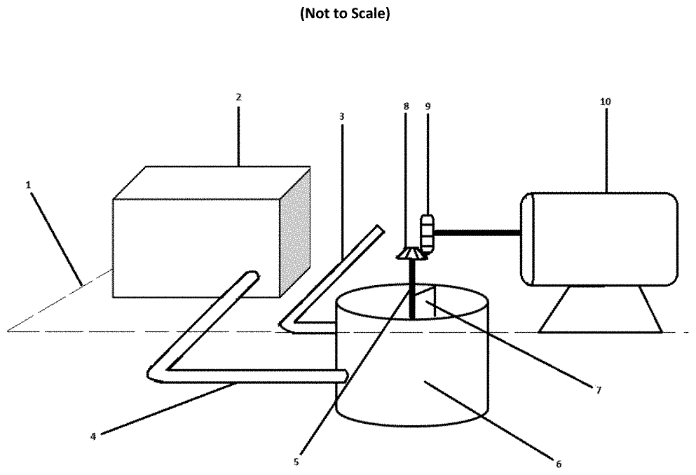

### CLAIM OF PRIORITY

The present application claims priority to and incorporates by reference U.S. Provisional Application No. 62/920,471 filed May 2, 2019 entitled “Generating Electricity Using the Outfall of a Waste Water Treatment Plant”

### BACKGROUND OF THE INVENTION

The present disclosure generally relates to an electrical power generating system using flowing water as the principal energy source.

The amount of energy available in falling water has attracted engineers looking for motive power since the beginning of the industrial revolution. Water has been used to generate electricity starting with the first days of electrical generation on an industrial scale. Most visible in large scale hydro projects marked by huge dams, micro hydro projects running in small streams and rivers have recently become more common as the search for clean, renewable energy is pursued. Recent innovations have included placing small generating turbines in municipal water lines to generate electricity as water is delivered to customers or to treatment plants. Whether massive dam, small stream, or pipeline, the common feature of these systems is the kinetic energy of flowing water. Waste Water Treatment Plants (WWTPs) provide a continuous flow of water from the final stage tank back to the river or other body of water the treated water is being released to. While the quantity of water released can be significant, in the millions of gallons per day, the velocity of the water is generally low as a result of the usually low head and deliberate effort to reduce the velocity so it does not cause damage/erosion when released to the already present water ecosystem. This low head and low velocity is the principal reason efforts are rarely made to generate electricity using the outflow while the principal efforts to extract useful energy from WWTPs is focused on the creation of methane using biomass left over from the treatment process. Prior art has addressed the issue of using water flow from treatment plants, both WWTP and those designed to generate potable water, to generate electricity. US Patent Application US 2019/0264649 A1 specifically addresses using the water from a WWTP to generate electricity, the same concept as the invention being disclosed in this application. However, there are significant differences in the two processes, principally in how the outflow is used to actually generate electricity by powering a generator.

### BRIEF SUMMARY OF THE INVENTION

The present invention uses the solid body effect, a property of non-compressible fluids such as water, to produce useful amounts of work that can be used to generate electricity. This novel approach increases the amount of work that can be done with the potential energy stored in the mass of the water flowing through the WWTP. One of the major obstacles the present invention overcomes is that in spite of there being a huge mass of water available from a WWTP, little actual work can be done with it because it is released over such a long period of time, in fact, most WWTPs are rated in gallons/day capacity as opposed to their continuous flow rate. The present invention alters the timeline over which the energy is utilized, and as work is defined as energy change/time change (de/dt), if dt can be decreased, work will be increased. The present invention also uses a mechanical system to turn the generator as opposed to a hydro system and so is able to use a conventional generator as opposed to one designed to be driven by fluid. In fact, the current invention is designed to turn a commercially available industrial scale wind turbine in the multi-megawatt generation range and without the need for 30 m blades.

### BRIEF DESCRIPTION OF THE ACCOMPANYING DRAWING

The present invention will be explained below by means of non-limiting examples with reference to the accompanying drawing, in which:

The drawing shows a view of the parts of one possible embodiment of the invention consisting of a representation of ground level, representation of a WWTP, a circular container with an inlet and outlet for water, a rotating shaft with an affixed paddle, possible gearing and a connection to a generator.

### DETAILED DESCRIPTION OF THE INVENTION

In the drawing, the dashed line 1 designates ground level. As can be seen in the drawing, in the preferred embodiment, the WWTP 2 and generator 10 are located on ground level, while the circular tank 6 is located mostly below ground level. This increases the downhill distance the water flows from the WWTP before entering the circular tank 6 thus increasing its head while at the same time allowing earth to be piled against the tank 6 reinforcing it against collapse. Water enters the circular tank 6 through the pipe 4 which acts as both the outlet for the WWTP 2 and the inlet for the tank 6. The inlet part of pipe 4 is aligned tangentially with the interior wall of the container to help impart rotation to the water in the tank 6. The inlet pipe 4 is sized based on the available volume of water to impart a velocity to the incoming water sufficient to induce rotation in the water in the tank as a whole. The outlet pipe 3 is located above the inlet. This means that only the top layer of the water is being removed, and the only energy lost removing water from the tank 6 is the energy needed to lift water above the inlet part of pipe 4 to outlet pipe 3. The present invention uses the solid body effect, this is where when a non-compressible liquid is contained and rotated, after the liquid is rotating cohesively, the liquid takes on the characteristics of a rigid body of the same mass. This allows the rotating liquid to assume the characteristics of a rigid body flywheel. This in turn allows the kinetic energy of the flowing water to be accumulated as rotational energy which can be used to rotate the shaft 5 through its connection to the paddle 7. Once the velocity of the rotating liquid and the incoming liquid are equal, the contained liquid will continue to rotate at the same velocity as long as liquid is continually injected into the container at the same velocity and volume that caused the initial rotation to begin and no additional load is applied. The water rotating in the tank 6 continuously pushes against the paddle 7 engaging gears 8 and 9 and turning the shaft connected to the generator 10. The water exiting through the outlet pipe 3 is slowed before it is released into the river or other body of water preventing possible erosion.

What is claimed is:

1. An electric power generation system comprising: the treated outflow from a water/waste water treatment plant or treated/untreated water outfall from another source; a containment vessel with a circular interior with a controllable inlet and outlet; a rotating shaft; a paddle affixed to the rotating shaft; a generator connected to the rotating shaft in such a manner the shaft can act on the generator; said generator connected to an electrical distribution system or battery(s)

2. The inlet and outlet of claim 1 being tangentially angled to induce and increase rotation of liquid inside the containment vessel;

3. The embodiment of claim 1 having multiple inlets and/or outlets.

4. The embodiment of claim 1 having multiple paddles, blades, fins or other means for extracting mechanical energy.

5. A means of injecting liquid into the embodiment of claim 1 by pump, gravity flow, or other mechanical or natural means.

6. The embodiment of claim 1 where the paddle or paddles are of a solid rigid construction.

7. The embodiment of claim 1 where the paddle or paddles are rigid, hollow, and filled with liquid.
